(19) United States
(12) Patent Application Publication
(10) Pub. No.: US 2026/0355963 A1
(43) Pub. Date: Nov. 12, 2026

(54) WORLD MODEL GATED PHYSICAL ARTIFICIAL INTELLIGENCE EXECUTION

(71) Applicant: Dorian Cartwright, San Jose, CA (US)

(72) Inventor: Dorian Cartwright, San Jose, CA (US)

(21) Appl. No.: 19/714,568

(22) Filed: Jun. 21, 2026

(51) Int. Cl. B25J 9/16

(52) U.S. Cl. CPC B25J 9/1674; B25J 9/163

(57) ABSTRACT

Execution of physical artificial intelligence is gated by a world model. A physical AI controller generates a candidate physical action, and a separate world model gating module receives the candidate action after generation and before transmission to an actuator interface. The world model gating module obtains a current physical-state representation and predicts future physical states associated with execution of the candidate action. A consequence evaluation engine evaluates the predicted future physical states against a constraint ledger including safety, resource, infrastructure, ownership, custody, identity, role, environmental, regulatory, policy, actuator, mission, or fleet constraints. An authorization interface issues an actuation release authorization when the constraints are satisfied and withholds authorization when at least one constraint is not satisfied. An actuator gateway permits motor-control commands only after verification of a valid actuation release authorization.

### CROSS-REFERENCE TO RELATED APPLICATIONS

This application is related to U.S. patent application Ser. No. 19/638,074, filed Apr. 2, 2026, entitled PREDICTIVE ACTUATION GATING IN PHYSICAL ARTIFICIAL INTELLIGENCE, by Dorian Cartwright, the entire contents of which are incorporated herein by reference.

This application is related to U.S. Patent Application No. 64/070,361, filed May 20, 2026, entitled HARDWARE-ENFORCED VALIDATED ACTUATION FOR AUTONOMOUS PHYSICAL ARTIFICIAL INTELLIGENCE SYSTEMS, by Dorian Cartwright, the entire contents of which are incorporated herein by reference.

This application is related to U.S. Patent Application No. 64/070,365, filed May 20, 2026, entitled PROTECTED PHYSICAL ARTIFICIAL INTELLIGENCE ACTUATOR FIREWALL OPERATING SYSTEM, by Dorian Cartwright, the entire contents of which are incorporated herein by reference.

This application is related to U.S. patent application Ser. No. 19/696,651, filed Jun. 3, 2026, entitled OWNERSHIP-GATED MISSION AUTHORIZATION AND CUSTODY CONTROL FOR MOBILE PHYSICAL ARTIFICIAL INTELLIGENCE AGENTS, by Dorian Cartwright, the entire contents of which are incorporated herein by reference.

This application is related to U.S. patent application Ser. No. 19/711,880, filed Jun. 17, 2026, entitled PHYSICAL ARTIFICIAL INTELLIGENCE OPERATING SYSTEM, by Dorian Cartwright, the entire contents of which are incorporated herein by reference.

### FIELD OF THE INVENTION

The present disclosure relates generally to computers and artificial intelligence, and more specifically, to using a world model as a mandatory authorization gate between generation of a candidate physical action and physical execution by one or more actuators.

### BACKGROUND

Physical artificial intelligence systems increasingly use vision-language-action models, robot foundation models, large language model planners, learned controllers, reinforcement learning policies, diffusion policies, classical planners, behavior trees, teleoperation streams, and hybrid autonomy stacks to generate candidate physical actions for robots, vehicles, drones, industrial machines, humanoids, mobile manipulators, and other embodied systems.

Such systems may generate actions that are plausible from the perspective of a planner or policy, but unsafe, unauthorized, inefficient, or noncompliant when physically executed. A robot may generate a reaching action that is geometrically plausible but that will strike a nearby human. A humanoid robot may generate a stair climbing action that appears valid in visual context but that will shift its center of mass beyond a stability margin. A mobile robot may generate a route Segment that is physically navigable but that violates a facility policy, ownership boundary, infrastructure access rule, or shared-space reservation. A robot arm may generate a tool-use action that is kinematically possible but that will exceed a force envelope, damage a workpiece, or violate a role-based authorization constraint.

Conventional robot systems often use simulation, digital twins, or predictive models during design, training, testing, validation, or planning. In such systems, a world model may help generate an action, optimize a trajectory, train a control policy, evaluate a simulated scenario, or provide advisory information to a planner. However, those systems do not necessarily require a world model based consequence evaluation as a condition precedent to physical actuation after a candidate action has already been generated.

Other systems use model predictive control, control barrier functions, safety rated monitors, geometric collision checkers, emergency stops, velocity limits, or static actuator constraints. Such techniques may improve control or safety, but they generally operate as controllers, filters, monitors, or mathematical safety sets rather than as a distinct authorization layer that receives an already-generated candidate action, predicts physical consequences using a world model, evaluates multi-domain constraints, and issues a discrete actuation release authorization required by an actuator gateway.

A technical gap therefore exists between action generation and physical execution. In particular, existing architectures often fail to provide a mandatory, non-bypassable world model authorization gate structurally interposed between a physical AI controller and an actuator interface, wherein the actuator interface remains disabled, fail-passive, blocked, or otherwise non-responsive to actuator commands unless a world-model-derived actuation release authorization has been verified.

There is a need for a robust world model as a mandatory authorization gate between generation of a candidate physical action and physical execution by one or more actuators.

### SUMMARY

The aforementioned shortcomings are addressed by systems, methods, and computer program products for world model gated physical artificial intelligence execution.

In one embodiment, a physical artificial intelligence system includes one or more decision models configured to generate a candidate physical action for a physical platform. The one or more decision models may include a vision-language-action model, robot foundation model, large language model agent, learned policy, learned controller, reinforcement learning policy, diffusion policy, classical planner, behavior tree, teleoperation interface, remote operator interface, or hybrid autonomy stack.

A world model gating module is structurally interposed between the one or more decision models and an actuator interface. The world model gating module receives the candidate physical action after generation by the one or more decision models and before transmission of the candidate physical action to one or more actuators. The world model gating module obtains a current physical-state representation of the physical platform and an operating environment. The current physical-state representation may include sensor data, robot state, actuator state, joint encoder data, tactile data, force-torque data, inertial data, RGB-D data, LiDAR data, radar data, scene graph data, occupancy data, object state, human proximity state, infrastructure state, mission state, resource state, or policy state.

The world model gating module executes a forward prediction using at least one world model to generate one or more future physical states, consequence trajectories, predicted physical consequence spaces, risk envelopes, or counterfactual outcomes associated with execution of the candidate physical action. The world model may include a world foundation model, learned dynamics model, physics simulator, differentiable simulator, digital twin, neural scene model, occupancy model, human-motion predictor, force predictor, contact predictor, fluid predictor, deformation predictor, balance predictor, thermal model, battery model, infrastructure model, or combinations thereof.

A consequence evaluation engine evaluates the predicted future states or consequence trajectories against a constraint ledger. The constraint ledger may include one or more constraint sets, including safety constraints, collision constraints, balance constraints, force constraints, tactile constraints, resource constraints, infrastructure constraints, ownership constraints, custody constraints, identity constraints, role constraints, environmental constraints, regulatory constraints, policy constraints, actuator constraints, mission constraints, fleet constraints, or facility constraints.

Responsive to determining that the predicted future states satisfy the constraint ledger, an authorization interface issues an actuation release authorization. The actuation release authorization may comprise a cryptographic token, signed data structure, capability grant, actuator-release certificate, time-bounded authorization, hardware verifiable command envelope, or system-level actuation permission. The actuation release authorization may identify an action hash, robot identifier, actuator scope, prediction horizon, world model identifier, world model version, predicted state hash, constraint-set identifiers, constraint satisfaction record, timestamp, validity window, issuing module identifier, execution envelope, revocation condition, or cryptographic signature.

An actuator gateway, actuator firewall, actuator controller, motor driver, locomotion controller, manipulation controller, brake controller, gripper controller, tool controller, or hardware enforcement circuit verifies the actuation release authorization before enabling torque, current, voltage, pulse width modulation, velocity, acceleration, jerk, force, braking release, locomotion, manipulation, tool power, propulsion, or other physical actuation. In some embodiments, the actuator gateway remains in a fail-passive state absent verification of a valid actuation release authorization associated with the candidate physical action.

Responsive to determining that the predicted future states fail to satisfy the constraint ledger, the system withholds the actuation release authorization and prevents physical execution of the candidate physical action. The system may block the candidate action, modify one or more parameters of the candidate action, decompose the candidate action into sub-actions, delay execution until a constraint clearance condition occurs, reroute the candidate action through an alternative spatial or temporal path, derate velocity, torque, force, power, current, acceleration, or jerk, request human approval, request infrastructure authorization, enter a conservative mode, trigger replanning, or transmit a constraint violation report to an upstream mission authorization system.

The disclosed architecture is distinct from using a world model to plan or generate an action. In the disclosed embodiments, the candidate physical action is generated independently of the world model gating module. The world model gating module evaluates the already generated candidate physical action after generation and before physical execution. Thus, the world model is used as a mandatory authorization gate, not merely as an advisory planning aid.

In some embodiments, a risk-adaptive world model selection policy selects among different world models based on risk level, action type, robot embodiment, human proximity, object fragility, environmental uncertainty, speed, force, infrastructure involvement, resource state, ownership state, network availability, or latency budget. Low risk actions may be evaluated using a lightweight local world model. Higher-risk actions may be evaluated using a higher fidelity local model, digital twin, cloud world model, world foundation model, fleet-level world model, or combination thereof.

In some embodiments, the system evaluates a null action or alternative candidate action in addition to the candidate physical action. The system may compare predicted consequences of executing the candidate physical action with predicted consequences of doing nothing, delaying, derating, or executing an alternative action. In emergencies, the system may authorize an action that would otherwise violate a lower priority constraint when a counterfactual null action would produce a greater predicted harm.

In some embodiments, the system continuously updates predicted future states during execution and dynamically modifies, suspends, renews, narrows, or revokes an actuation release authorization based on updated predicted consequences. An initially authorized action may be revoked mid-execution if updated sensor data causes the world model to predict violation of a constraint.

In some embodiments, prediction outcomes, constraint evaluations, authorization tokens, actuator commands, telemetry, observed outcomes, and prediction errors are recorded in an audit ledger, permission graph, or physical action authorization record. The record may be used for incident reconstruction, liability attribution, policy refinement, certification, insurance review, regulatory reporting, or world model improvement.

Many other variations are possible.

### BRIEF DESCRIPTION OF FIGURES

The present disclosure will be understood more fully from the detailed description given below and from the accompanying drawings of various embodiments of the disclosure.

FIG. 1 illustrates a system architecture for world model gated physical artificial intelligence execution that permits actuation only in response to a valid actuation release authorization, according to an embodiment.

FIG. 2 illustrates a world model gating module receiving a candidate physical action and a current physical-state representation and generating predicted future physical states, consequence trajectories, risk envelopes, and counterfactual outcomes, according to an embodiment.

FIG. 3 illustrates a state-snapshot pipeline for initializing a world model at a current time using sensor data, robot state, actuator state, environmental data, object state, human proximity, infrastructure state, mission state, and policy state, according to an embodiment.

FIG. 4 illustrates a semantic consequence extraction layer converting world model outputs into consequence indicators, according to an embodiment.

FIG. 5 illustrates a constraint ledger, according to an embodiment.

FIG. 6 illustrates an actuation release authorization token, according to an embodiment.

FIG. 7 illustrates a fail-passive actuator gateway configured to block, suppress, or prevent actuator commands absent verification of a valid actuation release authorization, according to an embodiment.

FIG. 8 illustrates structured remediation operations, according to an embodiment.

FIG. 9 illustrates risk-adaptive world model selection, according to an embodiment.

FIG. 10 illustrates a humanoid robot embodiment in which a candidate locomotion or manipulation action is gated by a world model before release to joint actuators, according to an embodiment.

FIG. 11 illustrates an autonomous mobile robot embodiment in which a navigation action is gated based on predicted future occupancy, collision, congestion, infrastructure, and policy constraints, according to an embodiment.

FIG. 12 illustrates an autonomous vehicle or drone embodiment in which candidate maneuvers are gated based on predicted future trajectories, regulatory constraints, infrastructure constraints, and environmental conditions.

FIG. 13 illustrates a multi-robot fleet embodiment in which a fleet-level world model predicts collective future states and issues actuation release authorizations for respective robots, according to an embodiment.

FIG. 14 illustrates a continuous runtime monitoring embodiment in which an actuation release authorization is renewed, narrowed, or revoked based on updated world model predictions during execution, according to an embodiment.

FIG. 15 illustrates a computing environment for implementing one or more components of the disclosed system, according to an embodiment.

FIG. 16 is a flow chart illustrating a method for world model gated physical AI execution in which a candidate physical action is received by a world model gate after generation by an upstream physical AI controller and before transmission to an actuator, according to an embodiment.

FIG. 17 is a flow chart illustrating a method for generating an actuation release authorization based on world model validation of a candidate physical action, according to an embodiment.

FIG. 18 is a flow chart illustrating a method for extracting semantic consequence indicators from world model simulation outputs and evaluating the semantic consequence indicators against constraint-ledger entries, according to an embodiment.

FIG. 19 is a flow chart illustrating a method for counterfactual validation of a candidate physical action by comparing a primary predicted trajectory with one or more counterfactual trajectories before physical actuation, according to an embodiment.

FIG. 20 is a flow chart illustrating a method for constraint ledger based actuation gating in which world model prediction outputs are evaluated against applicable constraints before a candidate physical action is released, modified, delayed, decomposed, rerouted, escalated, or blocked, according to an embodiment.

FIG. 21 is a flow chart illustrating a method for updating world model gating based on execution feedback, according to an embodiment.

### DETAILED DESCRIPTION

The description below provides systems, methods, and computer program products for world-model-gated physical artificial intelligence execution.

### I. Systems

### A. Overall Architecture for World Model Gated Physical AI Execution

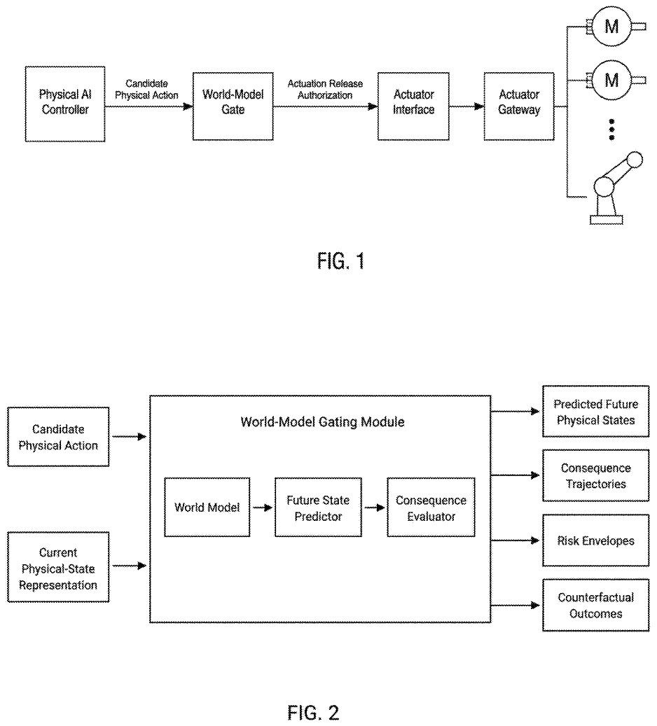

FIG. 1 illustrates a system architecture for world model gated physical artificial intelligence execution, according to an embodiment. As shown in FIG. 1, a physical artificial intelligence system includes a physical AI controller, a world model gate interposed between the physical AI controller and an actuator interface, and an actuator gateway configured to permit actuation only in response to a valid actuation release authorization.

A physical artificial intelligence system includes a physical platform, one or more decision models, a world model gating module, a consequence evaluation engine, an authorization interface, an actuator gateway, one or more actuator controllers, and one or more actuators.

The physical platform may be a humanoid robot, mobile robot, quadruped robot, robot arm, robotic hand, mobile manipulator, autonomous vehicle, drone, industrial robot, service robot, agricultural robot, construction robot, medical robot, surgical robot, warehouse robot, underwater robot, aerial robot, or other embodied system configured to physically interact with a real-world environment.

The one or more decision models generate candidate physical actions. A candidate physical action may be a machine-executable or machine-interpretable representation of a proposed physical behavior. The candidate physical action may include a joint trajectory, torque command, velocity command, steering command, braking command, thrust command, locomotion primitive, grasp primitive, manipulation sequence, tool-use instruction, route segment, mission segment, end-effector pose, force profile, stiffness setting, gripper closure instruction, gaze direction, head movement, sensor-orientation command, door-opening action, elevator-entry action, charging action, handoff action, object-placement action, or other actuation-related command.

The candidate physical action is generated by an upstream physical AI controller. The upstream physical AI controller may include one or more of a VLA model, robot foundation model, large language model agent, learned policy, learned controller, diffusion policy, reinforcement learning policy, neural controller, symbolic planner, classical motion planner, behavior tree, teleoperation stream, remote operator input, fleet-management system, mission planner, application, script, or hybrid controller.

As shown in FIG. 1, the world model gating module is separate from the upstream physical AI controller and is positioned after candidate-action generation but before actuator transmission. In some embodiments, separate means that the world model gating module is executed as a different process, runtime service, safety daemon, operating-system service, middleware component, actuator firewall service, secure enclave, trusted execution environment, hypervisor service, microcontroller service, hardware security module, or remote authorization service. In other embodiments, separate means that the world model gating module performs a function different from action generation: it evaluates an already-generated candidate physical action for authorization before actuation.

The world model gating module is structurally interposed between the physical AI controller and the actuator interface. Thus, the physical AI controller may propose actions, but proposed actions are not physically executable unless the world model gating module issues an actuation release authorization. This interposed architecture provides a post-generation, pre-actuation gate.

The actuator gateway may be part of a robot operating system, physical AI operating system, middleware layer, driver layer, actuator firewall, real-time controller, motor driver, firmware controller, safety controller, trusted runtime, hardware interlock, secure actuator interface, or combinations thereof. The actuator gateway may block transmission of actuator commands, suppress actuator commands, hold actuator commands in a queue, derate commands, clip commands, shape commands, require token verification, or otherwise prevent physical execution absent valid authorization.

### B. World Model Gating Module

FIG. 2 illustrates a world model gating module receiving a candidate physical action and a current physical-state representation and generating predicted future physical states, consequence trajectories, risk envelopes, and counterfactual outcomes, according to an embodiment.

The world model gating module receives a candidate physical action after the candidate physical action has been generated by the upstream physical AI controller and before the candidate physical action is transmitted to an actuator, actuator controller, motor controller, actuator driver, or physical execution layer. In some embodiments, the world model gating module also receives metadata associated with the candidate physical action, including source model identity, source process identity, action type, actuator identifier, actuator group, task identifier, mission identifier, confidence score, uncertainty score, expected contact indicator, object identifier, object fragility indicator, human-proximity state, deadline, priority, spatial frame, workflow stage, policy tags, and proposed execution envelope.

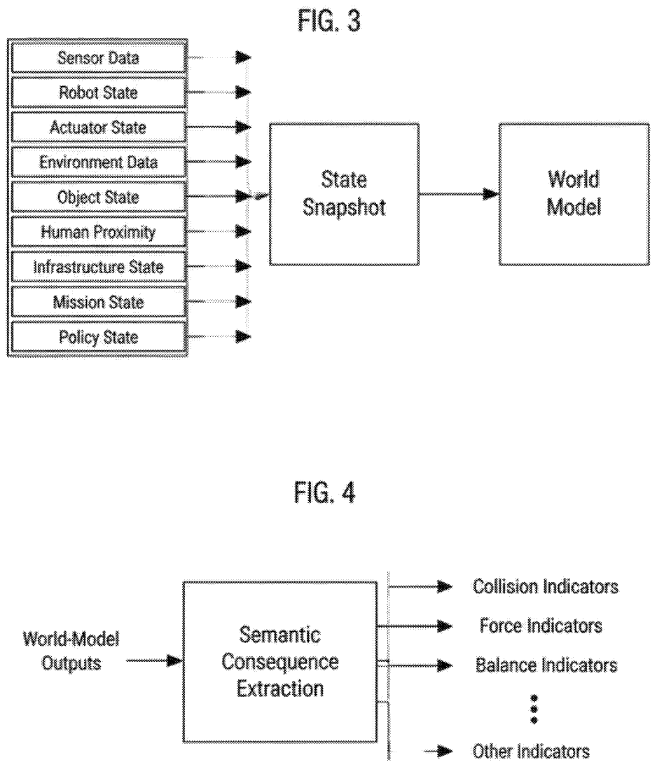

FIG. 3 illustrates a state-snapshot pipeline for initializing the world model at a current time using sensor data, robot state, actuator state, environmental data, object state, human proximity, infrastructure state, mission state, and policy state, according to an embodiment. The world model gating module obtains a current physical-state representation. The current physical-state representation may be generated from sensor data, onboard state, remote state, infrastructure state, fleet state, mission state, and policy state. The current physical-state representation may include RGB camera data, depth camera data, RGB-D data, LiDAR point cloud data, radar data, ultrasound data, microphone data, tactile data, pressure data, force-torque data, inertial measurement unit data, gyroscope data, accelerometer data, GPS data, wheel encoder data, joint encoder data, motor current data, motor temperature data, battery state, actuator health, gripper state, foot contact state, object pose, object velocity, human pose, human proximity, scene graph data, semantic map data, occupancy grid data, environmental hazard data, infrastructure availability, route data, custody state, ownership state, role state, policy state, and regulatory state.

The world model gating module initializes or updates a world model using the current physical-state representation. In some embodiments, initialization includes converting raw sensor data into a world model state vector, latent state, scene graph, voxel representation, occupancy representation, mesh representation, object graph, physics state, differentiable simulation state, or hybrid representation.

The world model predicts one or more future physical states associated with execution of the candidate physical action. A predicted future physical state may represent a predicted state of the robot, actuator, object, person, environment, infrastructure, resource, or fleet after execution of the candidate action. A consequence trajectory may represent a sequence of predicted future physical states over time. A risk envelope may represent a probability distribution, uncertainty-bounded set, worst-case boundary, ensemble output, confidence interval, collision envelope, force envelope, swept volume, reachable set, or multi-hypothesis prediction. A predicted physical consequence space may represent a set of possible future outcomes resulting from the candidate action.

The world model may be a learned world model trained on video, sensor data, robot telemetry, human demonstrations, physical interaction data, simulation data, synthetic data, fleet data, reinforcement learning rollouts, digital twin data, or combinations thereof. The world model may be a transformer-based model, diffusion model, recurrent model, state-space model, graph neural network, neural ordinary differential equation model, latent dynamics model, neural radiance or scene model, occupancy network, foundation model, multimodal model, video prediction model, or hybrid model.

The world model may also include a physics simulator, differentiable physics engine, rigid-body simulator, deformable-body simulator, contact simulator, fluid simulator, locomotion simulator, manipulation simulator, scene graph simulator, digital twin, model predictive simulator, learned dynamics model, semantic prediction model, rule-based simulator, or neuro-symbolic simulator.

In some embodiments, the world model is a composite world model. A composite world model may include a learned dynamics model for robot body motion, a physics simulator for contact, a semantic model for object and human interpretation, a digital twin for infrastructure, a resource model for energy, and a policy model for facility or jurisdictional constraints. Outputs of the composite world model may be fused, ranked, weighted, or evaluated according to a constraint policy.

C. Distinction from Planning Systems

The world model gating module does not need to generate the candidate physical action. The candidate physical action may be generated by an upstream physical AI controller independently of the world model gating module. The world model gating module receives the already-generated candidate physical action and evaluates predicted consequences of executing that candidate physical action before the candidate physical action is allowed to reach an actuator interface.

In some embodiments, the upstream physical AI controller may itself use a planner, simulator, world model, learned model, or optimization engine when generating the candidate physical action. Even in such cases, the disclosed world model gating module remains distinct because it performs a separate post-generation authorization evaluation. The system therefore may enforce a second, mandatory consequence-evaluation boundary even where the action generator used simulation or prediction internally.

Thus, the disclosed system is not directed merely to using a simulation or world model to assist in selecting an action. Rather, the disclosed system is directed to a post-selection, pre-actuation authorization gate in which an already-selected candidate physical action is independently evaluated by a world model, and physical actuation authority is withheld unless predicted consequences satisfy defined constraints.

This distinction is significant. A planning system produces an action or plan. The disclosed world model gating module produces an actuation authorization decision and, when appropriate, an actuation release authorization token. A planning system may optimize or generate a trajectory. The disclosed world model gating module authorizes or denies physical execution of a candidate trajectory or action that has already been generated. A planning system may use a predictive model as part of action generation. The disclosed system uses a predictive model as part of physical execution governance.

### D. Semantic Consequence Extraction Layer

FIG. 4 illustrates a semantic consequence extraction layer converting world model outputs into consequence indicators, according to an embodiment. In some embodiments, the world model outputs a predicted video sequence, latent tensor, scene graph, voxel representation, point cloud, mesh, state vector, future occupancy representation, or probability distribution. The semantic consequence extraction layer converts the world model output into consequence indicators suitable for evaluation against the constraint ledger.

A consequence indicator may include a predicted collision condition, predicted collision probability, predicted minimum distance, predicted force condition, predicted torque condition, predicted current draw, predicted balance condition, predicted center-of-mass violation, predicted zero-moment-point violation, predicted foot-slip condition, predicted grip-slip condition, predicted object fracture condition, predicted deformation condition, predicted liquid slosh condition, predicted spill condition, predicted human-proximity condition, predicted human-contact condition, predicted path-occupancy condition, predicted infrastructure-interaction condition, predicted resource depletion condition, predicted battery insufficiency condition, predicted thermal violation, predicted regulatory violation, predicted ownership violation, predicted identity or role violation, predicted policy violation, predicted mission failure, predicted environmental hazard, or predicted semantic hazard condition.

The semantic consequence extraction layer may use classifiers, detectors, thresholding, geometric measurement, physical calculation, force estimation, symbolic reasoning, rule evaluation, learned risk models, graph analysis, segmentation, object tracking, temporal tracking, collision detection, contact analysis, or combinations thereof. For example, a predicted video sequence may be processed to identify whether a human limb is contacted by a robot arm. A predicted voxel sequence may be processed to determine whether swept volume intersects a restricted zone. A predicted force trajectory may be processed to determine whether a fragile object fracture threshold is exceeded. A predicted occupancy trajectory may be processed to determine whether two robots will occupy a same shared region during an overlapping time interval.

### E. Constraint Ledger

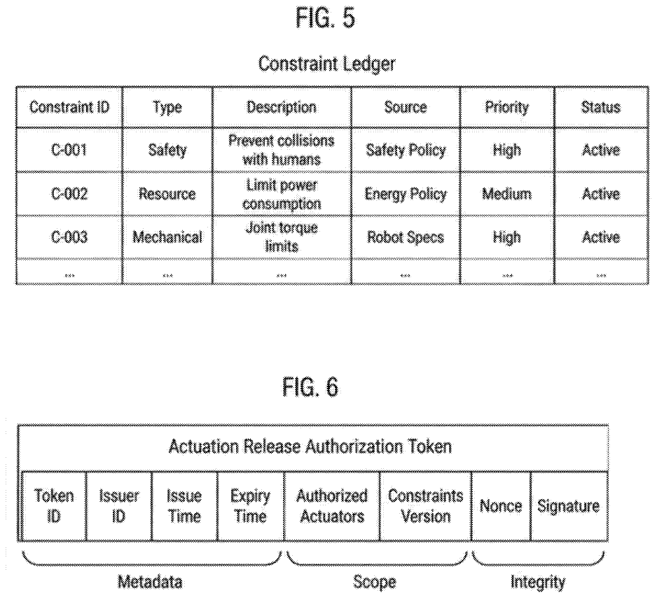

FIG. 5 illustrates a constraint ledger, according to an embodiment. The constraint ledger stores one or more constraint sets used to evaluate consequence indicators. The constraint ledger may be implemented as a database, policy table, rules engine, formal logic representation, graph, smart contract, signed policy object, immutable ledger, versioned policy store, regulatory rule store, facility rule store, mission authorization package, operating-system policy object, actuator policy map, or combinations thereof.

A safety constraint set may include collision avoidance, human separation, speed limits, force limits, torque limits, temperature limits, slip limits, balance margins, stability margins, braking margins, tool-use constraints, hazard avoidance, or emergency-stop conditions.

A resource constraint set may include battery state, energy reserve, thermal headroom, compute availability, network availability, coolant availability, actuator health, maintenance status, payload capacity, storage capacity, or time budget.

An infrastructure constraint set may include permitted elevators, doors, chargers, loading docks, vehicle bays, road segments, sidewalks, bridges, floors, workcells, tool stations, fixture stations, geofences, premises, shelves, storage regions, charging lanes, or restricted facility zones. Infrastructure constraints may include access rules, physical capacity limits, loading limits, time windows, occupancy rules, or availability states.

An ownership or custody constraint set may define whether a responsible party, owner, custodian, fleet operator, insurer, municipal authority, or other accountable entity has authorized the candidate action, object interaction, route, mission, or actuation class.

An identity or role constraint set may define whether the robot, controller, user, operator, application, model, planner, teleoperator, mission, or role is authorized to issue commands to the relevant actuator, object, area, tool, resource, or infrastructure.

An environmental constraint set may define weather limits, wind limits, wet-floor limits, terrain limits, friction limits, lighting limits, pollution limits, emissions limits, acoustic limits, environmental safety rules, or energy-use constraints.

A regulatory or policy constraint set may define rules from a facility, manufacturer, user, employer, insurer, regulator, municipality, roadway authority, aviation authority, maritime authority, premises operator, or other policy authority.

An actuator constraint set may include actuator-specific limits such as maximum torque, maximum current, maximum voltage, maximum speed, maximum acceleration, maximum jerk, maximum force, maximum duty cycle, maximum temperature, braking state, release state, allowed operating mode, or hardware health state.

A fleet constraint set may include shared occupancy, path coordination, inter-robot spacing, shared-load stability, common-object handling, resource contention, charging contention, communication quality, and cooperative task sequencing constraints.

In some embodiments, the constraint ledger is immutable or append-only for a given authorization interval. In other embodiments, the constraint ledger is versioned, and each actuation release authorization identifies the applicable constraint-ledger version used during evaluation.

### F. Consequence Evaluation Engine

The consequence evaluation engine evaluates the consequence indicators generated with reference to FIG. 4 against the constraint ledger described with reference to FIG. 5. The evaluation may be binary, threshold-based, probabilistic, worst-case, ensemble-based, priority-based, utility-based, rule-based, learned, or hybrid.

In some embodiments, all constraints in a selected constraint set must be satisfied before an actuation release authorization is issued. In other embodiments, constraints have priorities. For example, human safety constraints may override mission-completion constraints, ownership constraints may override resource-efficiency constraints, and emergency mitigation constraints may override lower-priority comfort constraints.

In some embodiments, the consequence evaluation engine evaluates multiple predicted futures generated by the world model. Multiple predicted futures may arise from uncertainty, probabilistic sampling, ensemble world models, different assumptions about human motion, different assumptions about object dynamics, or alternative environmental states. The consequence evaluation engine may require all predicted futures to satisfy constraints, require a worst-case future to satisfy constraints, require a risk score to be below a threshold, require a weighted probability of violation to be below a threshold, or require a particular confidence level.

In some embodiments, the consequence evaluation engine evaluates a null action, delay action, derated action, or alternative candidate action. A null action corresponds to doing nothing or maintaining a current actuator state. If a null action results in a worse predicted state than executing a candidate action, the consequence evaluation engine may temporarily widen a lower-priority constraint, issue a limited emergency authorization, or authorize a derated or modified action.

### G. Authorization Interface and Actuation Release Token

FIG. 6 illustrates an actuation release authorization token, according to an embodiment. The authorization interface issues an actuation release authorization when the consequence evaluation engine determines that the predicted future physical states satisfy the applicable constraints. The actuation release authorization may be a cryptographically signed token, digitally signed message, actuator certificate, capability token, runtime permission object, release envelope, command authorization object, policy clearance artifact, or other verifiable authorization.

The actuation release authorization may encode an action hash of the candidate physical action. The action hash may bind the authorization to the specific candidate physical action that was evaluated by the world model gating module. If a downstream actuator command differs from the authorized candidate physical action, the actuator gateway may reject the command.

The actuation release authorization may further encode a robot identifier, actuator identifier, actuator group, actuator scope, mission identifier, task identifier, object identifier, route segment, prediction horizon, world model identifier, world model version, world model confidence, predicted-state hash, risk envelope identifier, constraint-ledger version, constraint-set identifiers, constraint satisfaction record, time of issuance, validity window, maximum permitted latency before actuation, maximum speed, maximum force, maximum torque, maximum current, maximum voltage, maximum acceleration, maximum jerk, manipulation envelope, locomotion envelope, tool-use envelope, revocation condition, issuing module identifier, public key identifier, signature, or verification data.

In some embodiments, the token has a validity window. If actuation does not begin within the validity window, re-authorization is required. In some embodiments, the token authorizes only an initial segment of a longer action. A longer candidate action may be decomposed into a sequence of sub-actions, each requiring a separate token.

In some embodiments, the token is logged to an audit ledger, permission graph, physical-action authorization record, liability attribution ledger, certification log, insurance log, fleet-management log, or regulatory log. The log may preserve evidence of what action was proposed, what future states were predicted, what constraints were evaluated, what token was issued, what actuator command was executed, and what outcome was observed.

### H. Actuator Gateway and Fail-passive Operation

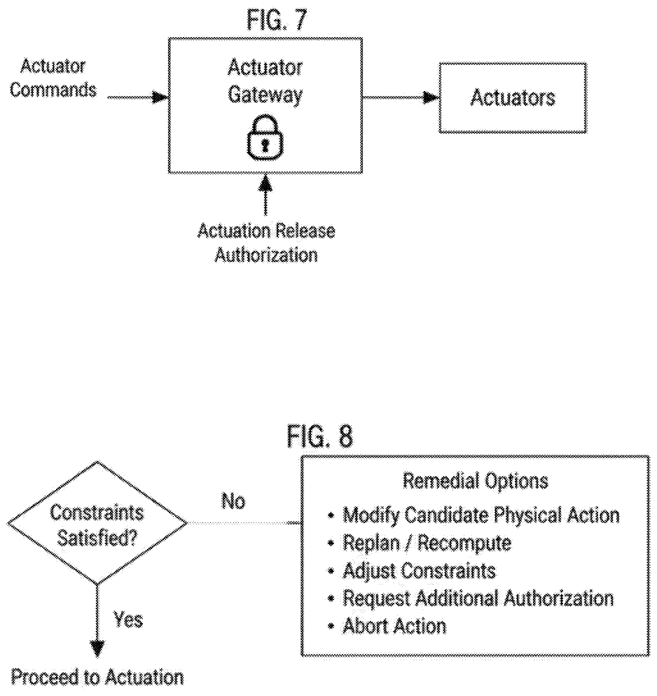

FIG. 7 illustrates a fail-passive actuator gateway configured to block, suppress, or prevent actuator commands absent verification of a valid actuation release authorization, according to an embodiment. The actuator gateway receives the candidate physical action, an actuator-directed command derived from the candidate physical action, or a lower-level command generated from the candidate physical action. The actuator gateway verifies the actuation release authorization before enabling physical execution.

The actuator gateway may verify a cryptographic signature, validity window, actuator scope, action hash, robot identifier, actuator identifier, constraint satisfaction record, world model version, revocation status, policy version, or command envelope. The actuator gateway may also verify that the actuator-directed command is within a permitted execution envelope encoded by the actuation release authorization.

If verification succeeds, the actuator gateway may permit, transmit, shape, clip, derate, or otherwise execute the actuator-directed command. If verification fails or the token is absent, expired, revoked, mismatched, or outside scope, the actuator gateway blocks, suppresses, ignores, quarantines, or rejects the command.

In some embodiments, the actuator gateway remains in a fail-passive state absent verification of a valid actuation release authorization. A fail-passive state may include a state in which a motor driver does not energize a motor, a brake remains engaged, a gripper does not close, a tool is not powered, a propulsion controller does not produce thrust, a locomotion controller does not step, a valve remains closed, a relay remains open, a power stage remains disabled, a pulse-width modulation output remains suppressed, or an actuator command queue remains blocked.

### I. Structured Remediation

FIG. 8 illustrates structured remediation operations, according to an embodiment. When the predicted future physical states fail to satisfy the constraint ledger, the system may withhold the actuation release authorization and perform structured remediation.

Blocking may include rejecting the candidate physical action and preventing transmission to actuators. Modification may include changing one or more parameters of the candidate physical action, such as speed, trajectory, force, torque, current, voltage, acceleration, jerk, stiffness, grip force, timing, path, or tool setting. Derating may include reducing a speed, force, torque, current, acceleration, jerk, power, thrust, or duty-cycle parameter to a level at which constraint satisfaction is predicted.

Decomposition may include dividing a candidate physical action into a plurality of sub-actions, each having a smaller prediction horizon, lower risk, more limited actuator scope, or more easily evaluated consequence profile. Each sub-action may be separately submitted to the world model gating module and separately authorized.

Delay may include holding the candidate physical action until a constraint clearance condition occurs, such as a human leaving a workspace, a robot leaving a shared region, a door opening, a charger becoming available, a route becoming clear, an object being removed, a battery charging, or a policy authorization arriving.

Rerouting may include generating or requesting an alternative spatial path, temporal path, route segment, grasp approach, foot placement, tool path, lane change, flight path, or object handoff plan.

Replanning may include transmitting a constraint violation report to the upstream physical AI controller. The report may identify which predicted future state violated which constraint, and may include a suggested constraint, envelope, region, timing, or parameter for generating a new candidate action.

In some embodiments, structured remediation produces a modified candidate action that is resubmitted to the world model gating module. The modified candidate action is not executed unless it also receives an actuation release authorization.

### J. Risk-Adaptive World Model Selection

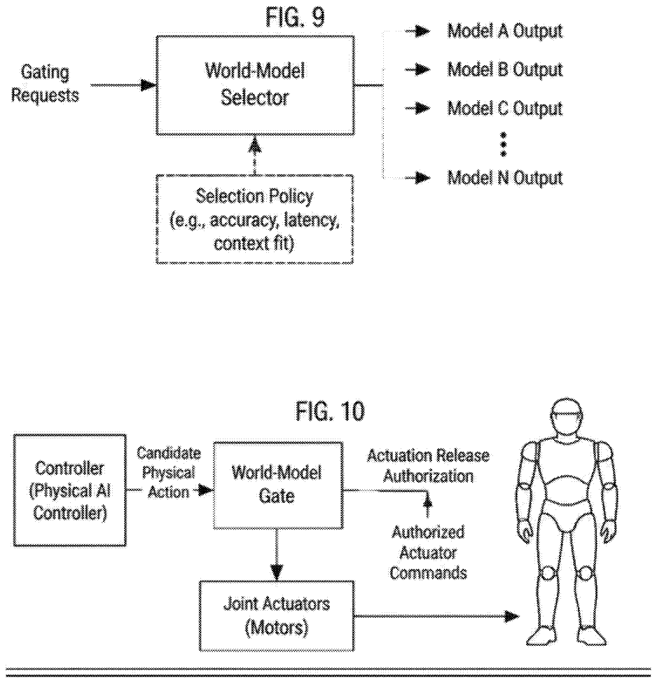

FIG. 9 illustrates risk-adaptive world model selection, according to an embodiment. In some embodiments, the system includes a world model selection policy. The world model selection policy determines which world model or combination of world models to use for a given candidate physical action.

The world model selection policy may evaluate action type, action speed, expected contact, human proximity, object fragility, object value, force level, torque level, public-space exposure, infrastructure interaction, resource dependency, uncertainty, novelty, mission class, ownership risk, regulatory risk, environmental risk, network availability, compute availability, latency budget, and actuator criticality.

A low-risk non-contact action may be evaluated with a lightweight local world model. A high-risk human-adjacent action may be evaluated with a higher-fidelity local model. An action involving fragile objects, public infrastructure, vehicle interaction, or multi-robot coordination may be evaluated using a digital twin, cloud world model, fleet-level world model, or world foundation model. If a cloud model is unavailable, the system may block the action, use a conservative local fallback model, narrow the permitted action envelope, or authorize only low-risk sub-actions.

### K. Continuous Runtime Monitoring and Revocation

FIG. 14 illustrates a continuous runtime monitoring embodiment in which an actuation release authorization is renewed, narrowed, or revoked based on updated world model predictions during execution, according to an embodiment.

In some embodiments, the world model gating process continues after an initial authorization. During execution, the system receives updated sensor data, robot state, environmental state, human state, object state, resource state, and actuator feedback. The world model updates predicted future states. The consequence evaluation engine determines whether the authorization remains valid.

If updated predictions indicate that a constraint will be violated, the system may revoke the actuation release authorization, issue a narrowed authorization, derate an actuator command, engage a brake, pause motion, request replanning, or enter a conservative mode. The actuator gateway may periodically check whether the token remains valid or whether a revocation record exists.

In some embodiments, the actuation release authorization includes renewal requirements. For example, a humanoid robot taking multiple steps may require renewed tokens for successive step groups. A robot arm moving through a multi-stage manipulation sequence may require new tokens for approach, contact, grasp, lift, transport, and release stages.

### L. Prediction Error Logging and World Model Improvement

In some embodiments, the system compares observed outcomes to predicted future states. The comparison may identify prediction error, constraint false positive, constraint false negative, world model drift, environment mismatch, sensor uncertainty, actuator deviation, or policy mismatch.

The system may use prediction errors to update the world model, recalibrate thresholds, adjust confidence scores, change model-selection policy, modify constraint priorities, update digital twins, generate training data, update simulation parameters, or produce incident reports. In some embodiments, significant prediction error causes future candidate actions of a similar class to require a higher-fidelity world model or human approval.

### M. Humanoid Robot Embodiments

FIG. 10 illustrates a humanoid robot embodiment in which a candidate locomotion or manipulation action is gated by a world model before release to joint actuators, according to an embodiment.

In a humanoid robot embodiment, a physical AI controller generates a candidate action such as stepping onto a stair, reaching toward an object, handing a tool to a person, opening a door, lifting a package, walking through a crowd, sitting, standing, catching an object, or manipulating a fragile item.

The world model gating module receives a current physical-state representation including body pose, joint angles, foot contact, center of mass, tactile state, grasp state, object pose, human proximity, terrain geometry, and mission context. A world model predicts future body pose, contact states, center-of-mass trajectory, balance margin, hand forces, object state, and human proximity resulting from the candidate action.

The consequence evaluation engine evaluates safety, balance, force, object integrity, ownership, role, and policy constraints. If the predicted center of mass exits a stability envelope, if a predicted hand force exceeds an object fragility threshold, if a predicted arm path intersects a human safety zone, or if an object is not authorized for the robot's role, the system withholds the token and blocks, modifies, decomposes, delays, reroutes, derates, or replans the candidate action.

### N. Autonomous Mobile Robot Embodiments

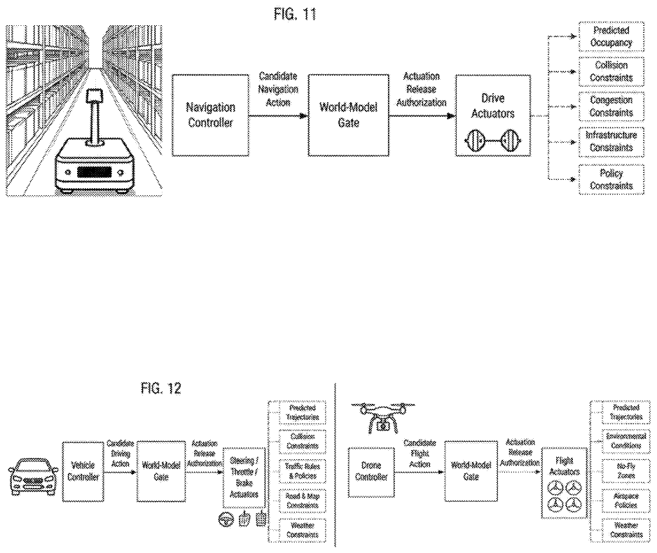

FIG. 11 illustrates an autonomous mobile robot embodiment in which a navigation action is gated based on predicted future occupancy, collision, congestion, infrastructure, and policy constraints, according to an embodiment.

In an autonomous mobile robot embodiment, a candidate action may include a velocity command, waypoint, path segment, aisle entry, turn, docking maneuver, loading maneuver, unloading maneuver, elevator-entry action, or charging action.

The world model predicts future robot position, swept volume, path occupancy, human proximity, other-robot positions, payload stability, battery state, and infrastructure interaction. The consequence evaluation engine evaluates collision, shared-space, floor-load, geofence, aisle-priority, charging, ownership, and policy constraints.

If a predicted future occupancy conflicts with another robot, the system may delay or reroute the candidate action. If a payload is predicted to tip during a turn, the system may derate angular velocity. If a robot is not authorized to enter a zone, the system may withhold authorization.

### O. Autonomous Vehicle and Drone Embodiments

FIG. 12 illustrates an autonomous vehicle or drone embodiment in which candidate maneuvers are gated based on predicted future trajectories, regulatory constraints, infrastructure constraints, and environmental conditions, according to an embodiment.

In an autonomous vehicle embodiment, a candidate action may include a lane change, merge, braking maneuver, acceleration, turn, parking maneuver, intersection entry, or route segment. The world model predicts future vehicle state, nearby vehicle trajectories, pedestrian movement, braking distance, road condition effects, infrastructure interaction, and regulatory compliance.

The consequence evaluation engine may evaluate traffic rules, right-of-way, road-surface constraints, bridge or lane restrictions, environmental conditions, human safety, insurance state, role authorization, and policy constraints. The actuation gateway may gate steering, throttle, braking, propulsion, signaling, or other vehicle control.

In a drone embodiment, a candidate action may include a flight path, altitude change, landing action, takeoff action, payload release, hover, route segment, or return-to-base action. The world model predicts airspace occupancy, wind effects, battery depletion, collision risk, signal loss, no-fly-zone intrusion, and infrastructure proximity. The consequence evaluation engine may evaluate airspace authorization, pilot or operator role, weather, battery reserve, RF link margin, payload safety, and regulatory constraints.

### P. Robot Arm and Industrial Embodiments

In a robot arm embodiment, a candidate action may include a joint trajectory, end-effector pose, tool path, grasp, insertion, welding motion, cutting motion, polishing motion, painting motion, assembly action, or collaborative robot movement.

The world model predicts joint torques, end-effector position, contact forces, tool interaction, workpiece deformation, fixture interaction, human proximity, surface quality, and process quality. The consequence evaluation engine evaluates workspace boundaries, ISO-style safety zones, force limits, tool authorization, workpiece ownership, process recipe, fixture state, and quality constraints.

If predicted contact force exceeds a threshold, the system may derate force or modify the trajectory. If a tool path is predicted to damage a workpiece, the system may block the action or request a new path. If a robot attempts to act on the wrong workpiece, the system may withhold the token.

### Q. Multi-Robot Fleet Embodiments

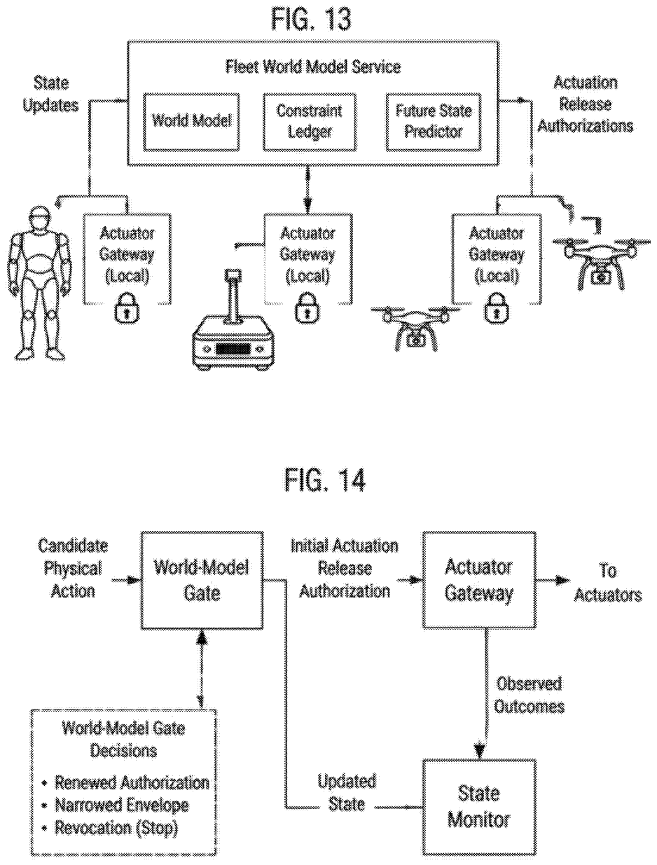

FIG. 13 illustrates a multi-robot fleet embodiment in which a fleet-level world model predicts collective future states and issues actuation release authorizations for respective robots, according to an embodiment.

In a multi-robot fleet embodiment, a world model predicts a collective future state of a plurality of physical AI agents. The world model may be local to one robot, distributed among robots, executed by a fleet server, executed by infrastructure, or executed by a cloud world model service.

The collective future state may include predicted positions, velocities, swept volumes, shared object states, shared load stability, resource usage, charging station occupancy, infrastructure usage, task sequencing, and hazard interactions. The consequence evaluation engine may detect resource conflicts, predicted collisions, shared-object instability, task-order violations, or fleet policy violations.

The authorization interface may issue actuation release authorizations to one robot, a subset of robots, or multiple robots with coordinated timing. In a conflict, the system may authorize one robot and deny another, delay one action, reroute another, or generate a coordinated multi-robot action set.

### R. Cloud and Edge Embodiments

In some embodiments, the world model gating module executes onboard the physical AI agent. In other embodiments, the world model gating module executes on an edge server, facility controller, cloud service, fleet server, infrastructure device, or hybrid architecture.

When a remote world model is used, the physical AI agent may transmit a candidate action and state snapshot to the remote world model gating module. The remote module may return an actuation release authorization, denial, modified action, derated envelope, or replanning request. To account for network latency, the system may expand a prediction horizon, apply conservative uncertainty bounds, authorize only low-risk sub-actions, require local verification, or fall back to a local safe model.

In some embodiments, the system precomputes likely world model predictions for anticipated candidate actions before the actions are generated or before they reach the gate. Precomputation may reduce latency. However, physical execution still requires a post-generation actuation release authorization corresponding to the actual candidate action and current physical-state representation.

### S. Computing Environment

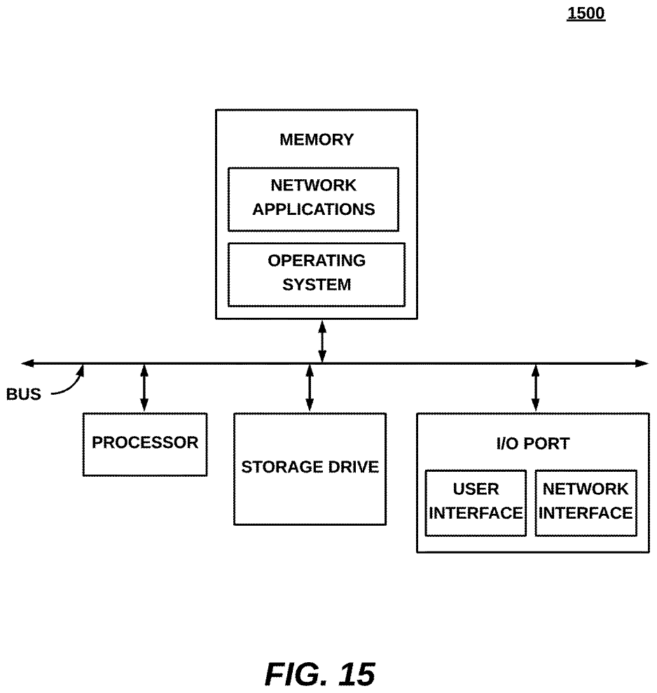

FIG. 15 illustrates a computing environment for implementing one or more components of the disclosed system, according to an embodiment.

The components described herein may be implemented using one or more processors, memories, storage devices, communication interfaces, sensors, actuators, and software instructions. A processor may include a CPU, GPU, TPU, NPU, ASIC, FPGA, DSP, microcontroller, safety controller, robot controller, motor controller, secure enclave processor, hardware security module, or other processing device.

Memory may include RAM, SRAM, DRAM, HBM, flash memory, persistent memory, accelerator memory, controller memory, or storage-backed memory. Software may be implemented as an operating-system service, middleware layer, robot operating system package, firmware, microcode, runtime module, cloud service, local daemon, containerized service, safety-certified module, or distributed system.

### II. Methods

### A. Method for World Model Gated Physical AI Execution

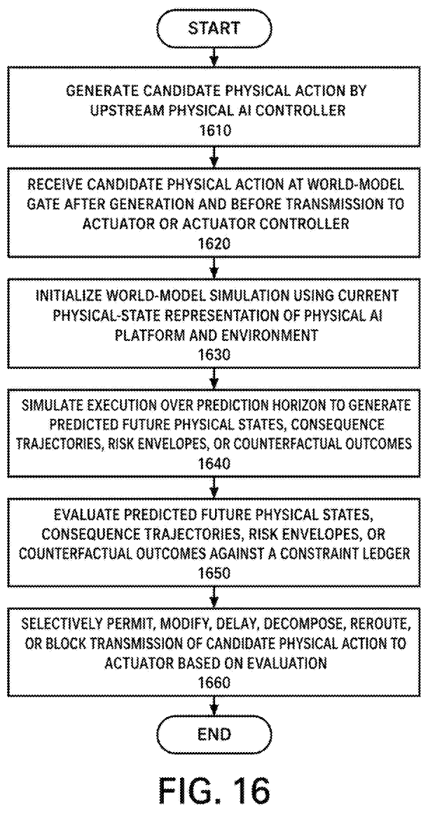

FIG. 16 is a flow chart illustrating a method for world-model-gated physical AI execution, according to an embodiment.

At step 1610, a candidate physical action is generated by an upstream physical AI controller of a physical AI platform.

At step 1620, the candidate physical action is received by a world model gate after the candidate physical action is generated by the upstream physical AI controller and before the candidate physical action is transmitted to an actuator or actuator controller.

At step 1630, the world model gate initializes a world model simulation using a current physical-state representation of the physical AI platform and an environment in which the physical AI platform is operating.

At step 1640, the world model gate simulates execution of the candidate physical action over a prediction horizon to generate predicted future physical states, consequence trajectories, risk envelopes, or counterfactual outcomes.

At step 1650, the world model gate evaluates the predicted future physical states, consequence trajectories, risk envelopes, or counterfactual outcomes against a constraint ledger.

At step 1660, the world model gate selectively permits, modifies, delays, decomposes, reroutes, or blocks transmission of the candidate physical action to the actuator based on the evaluation.

### B. Method for Generating an Actuation Release Authorization

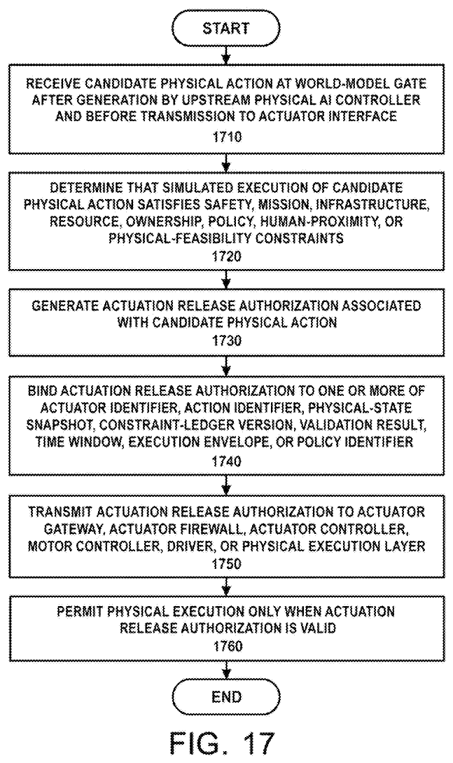

FIG. 17 is a flow chart illustrating a method for generating an actuation release authorization from world model validation, according to an embodiment.

At step 1710, a candidate physical action is received at a world model gate after generation by an upstream physical AI controller and before transmission to an actuator interface.

At step 1720, the world model gate determines that simulated execution of the candidate physical action satisfies safety, mission, infrastructure, resource, ownership, policy, human-proximity, or physical-feasibility constraints.

At step 1730, the world model gate generates an actuation release authorization associated with the candidate physical action.

At step 1740, the actuation release authorization is bound to one or more of an actuator identifier, action identifier, physical-state snapshot, constraint-ledger version, validation result, time window, execution envelope, or policy identifier.

At step 1750, the actuation release authorization is transmitted to an actuator gateway, actuator firewall, actuator controller, motor controller, driver, or physical execution layer.

At step 1760, the actuator gateway, actuator firewall, actuator controller, motor controller, driver, or physical execution layer permits physical execution only when the actuation release authorization is valid.

### C. Method for World Model Consequence Extraction

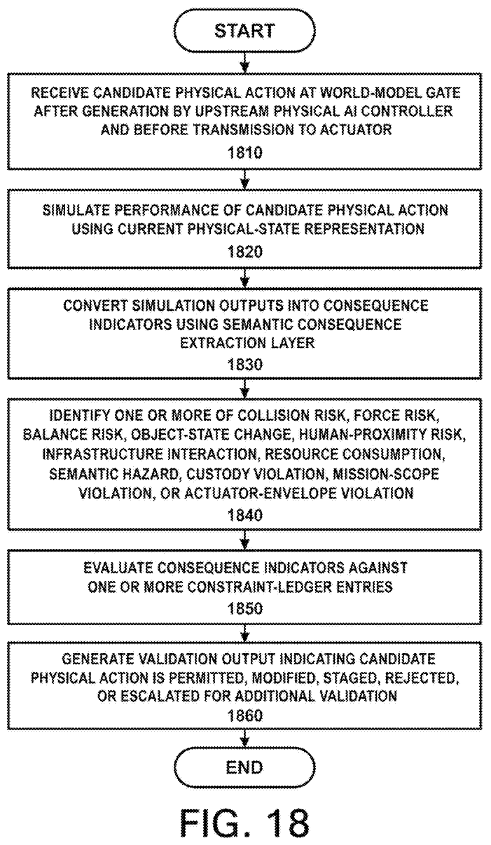

FIG. 18 is a flow chart illustrating a method for extracting semantic consequences from world model simulation outputs, according to an embodiment.

At step 1810, a world model gate receives a candidate physical action after the candidate physical action is generated by an upstream physical AI controller and before the candidate physical action is transmitted to an actuator.

At step 1820, the world model gate simulates performance of the candidate physical action using a current physical-state representation.

At step 1830, a semantic consequence extraction layer converts simulation outputs into consequence indicators.

At step 1840, the consequence indicators identify one or more of collision risk, force risk, balance risk, object-state change, human-proximity risk, infrastructure interaction, resource consumption, semantic hazard, custody violation, mission-scope violation, or actuator-envelope violation.

At step 1850, the world model gate evaluates the consequence indicators against one or more constraint-ledger entries.

At step 1860, the world model gate generates a validation output indicating whether the candidate physical action is permitted, modified, staged, rejected, or escalated for additional validation.

### D. Method for Counterfactual World Model Validation

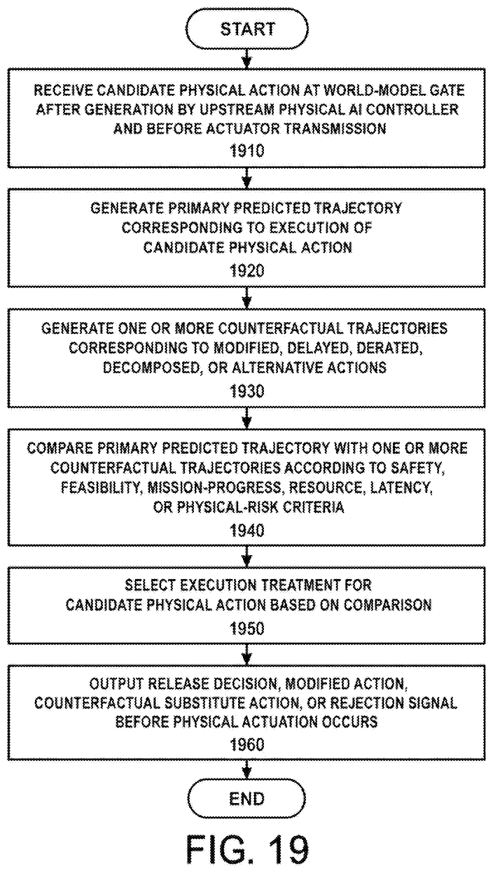

FIG. 19 is a flow chart illustrating a method for counterfactual validation of a candidate physical action, according to an embodiment.

At step 1910, a world model gate receives a candidate physical action after generation by an upstream physical AI controller and before actuator transmission.

At step 1920, the world model gate generates a primary predicted trajectory corresponding to execution of the candidate physical action.

At step 1930, the world model gate generates one or more counterfactual trajectories corresponding to modified, delayed, derated, decomposed, or alternative actions.

At step 1940, the world model gate compares the primary predicted trajectory with the one or more counterfactual trajectories according to safety, feasibility, mission-progress, resource, latency, or physical-risk criteria.

At step 1950, the world model gate selects an execution treatment for the candidate physical action based on the comparison.

At step 1960, the world model gate outputs a release decision, modified action, counterfactual substitute action, or rejection signal before physical actuation occurs.

### E. Method for Constraint-Ledger-Based Actuation Gating

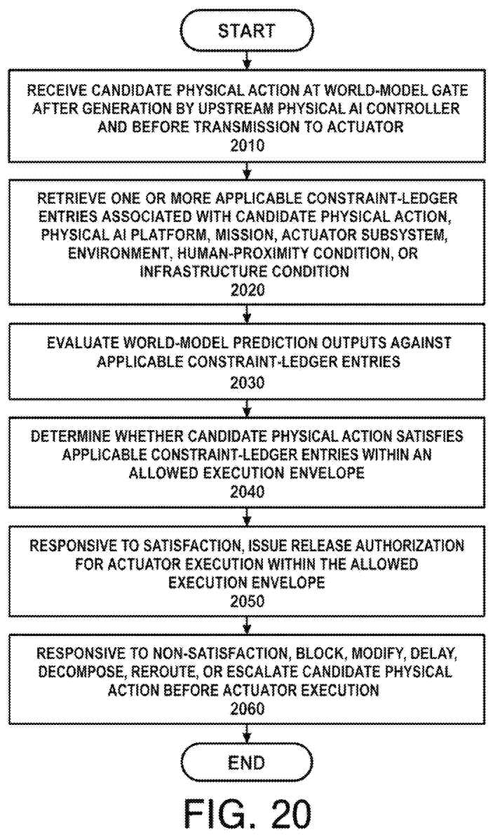

FIG. 20 is a flow chart illustrating a method for constraint-ledger-based actuation gating, according to an embodiment.

At step 2010, a candidate physical action is received by a world model gate after generation by an upstream physical AI controller and before transmission to an actuator.

At step 2020, the world model gate retrieves one or more applicable constraint-ledger entries associated with the candidate physical action, a physical AI platform, a mission, an actuator subsystem, an environment, a human-proximity condition, or an infrastructure condition.

At step 2030, the world model gate evaluates world model prediction outputs against the applicable constraint-ledger entries.

At step 2040, the world model gate determines whether the candidate physical action satisfies the applicable constraint-ledger entries within an allowed execution envelope.

At step 2050, responsive to satisfaction of the applicable constraint-ledger entries, the world model gate issues a release authorization for actuator execution within the allowed execution envelope.

At step 2060, responsive to non-satisfaction of at least one applicable constraint-ledger entry, the world model gate blocks, modifies, delays, decomposes, reroutes, or escalates the candidate physical action before actuator execution.

F. Method for Updating World model Gating Based on Execution Feedback

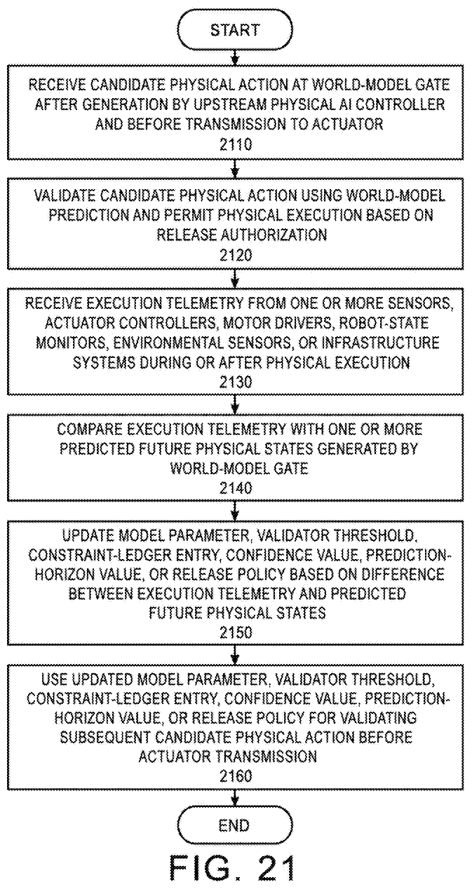

FIG. 21 is a flow chart illustrating a method for updating world model gating based on execution feedback, according to an embodiment.

At step 2110, a candidate physical action is received by a world model gate after generation by an upstream physical AI controller and before transmission to an actuator.

At step 2120, the world model gate validates the candidate physical action using world model prediction and permits physical execution based on a release authorization.

At step 2130, execution telemetry is received from one or more sensors, actuator controllers, motor drivers, robot-state monitors, environmental sensors, or infrastructure systems during or after physical execution.

At step 2140, the execution telemetry is compared with one or more predicted future physical states generated by the world model gate.

At step 2150, the world model gate updates a model parameter, validator threshold, constraint-ledger entry, confidence value, prediction-horizon value, or release policy based on a difference between the execution telemetry and the predicted future physical states.

At step 2160, the updated model parameter, validator threshold, constraint-ledger entry, confidence value, prediction-horizon value, or release policy is used for validating a subsequent candidate physical action before actuator transmission.

### III. Generalities

The disclosed embodiments may be combined in various ways. A world model gating module may operate locally, remotely, or in a hybrid fashion. A world model may be learned, analytic, physics-based, symbolic, neural, differentiable, probabilistic, deterministic, or a combination thereof. A consequence evaluation engine may use hard constraints, soft constraints, learned constraints, probabilistic constraints, policy constraints, or priority-ranked constraints.

The disclosed system may interoperate with actuator firewalls, operating-system-level AI firewalls, ownership-gated mission authorization systems, custody control systems, physical AI operating systems, robot middleware, motor drivers, safety controllers, fleet-management systems, infrastructure access systems, charging systems, and audit ledgers.

The term “world model” should be understood broadly to encompass any model, simulator, digital twin, learned dynamics model, scene model, foundation model, or predictive consequence model configured to predict physical consequences of a candidate action in a physical environment.

The term “actuation release authorization” should be understood broadly to encompass a token, signed object, command envelope, permission, certificate, release signal, policy grant, or other verifiable authorization used to permit physical execution.

The term “fail-passive” should be understood broadly to encompass a state in which an actuator interface does not produce physical actuation absent valid authorization. Fail-passive operation may include maintaining zero torque, suppressing current, holding a brake, disabling a power stage, ignoring commands, preventing command transmission, or entering a safe state.

The present disclosure is not limited to any particular robot, actuator, world model, or safety standard. The disclosed architecture may be applied to physical AI systems in homes, hospitals, factories, warehouses, roadways, sidewalks, campuses, airports, farms, construction sites, retail spaces, fulfillment centers, transportation systems, public spaces, private facilities, industrial facilities, and other environments.

I claim:

1. A physical artificial intelligence system comprising:
one or more decision models configured to generate a candidate physical action for a physical platform;
a world model gating module, separate from the one or more decision models, configured to receive the candidate physical action after generation of the candidate physical action by the one or more decision models and before transmission of the candidate physical action to an actuator interface;
the world model gating module further configured to obtain a current physical-state representation of the physical platform and an operating environment and to predict, using at least one world model, one or more future physical states associated with execution of the candidate physical action;
a consequence evaluation engine configured to evaluate the one or more future physical states against a constraint ledger comprising a plurality of constraint sets;
an authorization interface configured to issue an actuation release authorization in response to determining that the one or more future physical states satisfy the plurality of constraint sets, and to withhold the actuation release authorization in response to determining that at least one of the plurality of constraint sets is not satisfied; and
an actuator gateway configured to permit a motor-control command for one or more actuators only in response to verification of a valid actuation release authorization associated with the candidate physical action.

2. The physical artificial intelligence system of claim 1, wherein the one or more decision models comprise at least one of a vision-language-action model, robot foundation model, large language model agent, reinforcement learning policy, diffusion policy, learned controller, classical planner, behavior tree, teleoperation interface, or hybrid autonomy stack.

3. The physical artificial intelligence system of claim 1, wherein the at least one world model comprises at least one of a world foundation model, digital twin, learned dynamics model, physics simulator, differentiable simulator, occupancy model, human-motion predictor, force predictor, contact predictor, balance predictor, infrastructure model, or fleet-level world model.

4. The physical artificial intelligence system of claim 1, wherein the current physical-state representation comprises at least one of sensor data, robot state, actuator state, joint encoder data, tactile data, force-torque data, inertial data, RGB-D data, LiDAR data, scene graph data, object state, human proximity state, infrastructure state, mission state, resource state, ownership state, or policy state.

5. The physical artificial intelligence system of claim 1, further comprising a semantic consequence extraction layer configured to extract, from the one or more future physical states, one or more consequence indicators comprising at least one of a predicted collision condition, predicted force condition, predicted balance condition, predicted object-state condition, predicted human-proximity condition, predicted infrastructure condition, predicted resource condition, predicted ownership condition, or predicted semantic hazard condition.

6. The physical artificial intelligence system of claim 1, wherein the plurality of constraint sets comprise at least two of a safety constraint set, resource constraint set, infrastructure constraint set, ownership constraint set, custody constraint set, identity constraint set, role constraint set, environmental constraint set, regulatory constraint set, policy constraint set, actuator constraint set, mission constraint set, or fleet constraint set.

7. The physical artificial intelligence system of claim 1, wherein the actuation release authorization comprises a cryptographic token encoding at least one of an action hash, robot identifier, actuator scope, prediction horizon, world model identifier, world model version, predicted-state hash, constraint-set identifier, constraint satisfaction record, timestamp, validity window, execution envelope, revocation condition, or cryptographic signature.

8. The physical artificial intelligence system of claim 1, wherein the actuator gateway is configured to remain in a fail-passive state absent verification of the valid actuation release authorization.

9. The physical artificial intelligence system of claim 1, wherein the actuator gateway comprises at least one of an actuator firewall, motor driver, locomotion controller, manipulation controller, brake controller, gripper controller, tool controller, firmware controller, hardware interlock, or secure actuator interface.

10. The physical artificial intelligence system of claim 1, wherein the authorization interface is further configured, responsive to determining that at least one of the plurality of constraint sets is not satisfied, to cause at least one of blocking, modifying, decomposing, delaying, rerouting, derating, requesting human approval, requesting infrastructure authorization, entering a conservative mode, or requesting replanning of the candidate physical action.

11. The physical artificial intelligence system of claim 1, further comprising a risk-adaptive world model selection policy configured to select the at least one world model from a plurality of world models based on at least one of risk level, action type, human proximity, object fragility, expected contact, public-space exposure, infrastructure interaction, environmental uncertainty, resource state, latency budget, or network availability.

12. The physical artificial intelligence system of claim 1, wherein the world model gating module is further configured to predict a counterfactual future state associated with a null action or an alternative candidate action and to compare the counterfactual future state with the one or more future physical states associated with execution of the candidate physical action.

13. The physical artificial intelligence system of claim 1, wherein the world model gating module is further configured to update the one or more future physical states during execution of an authorized action, and wherein the authorization interface is configured to revoke, narrow, renew, or replace the actuation release authorization based on the updated one or more future physical states.

14. The physical artificial intelligence system of claim 1, further comprising an audit ledger or permission graph configured to record relationships among the candidate physical action, the current physical-state representation, a world model version, the one or more future physical states, the plurality of constraint sets, the actuation release authorization, an actuator command, telemetry, and an observed outcome.

15. The physical artificial intelligence system of claim 1, wherein the physical platform comprises at least one of a humanoid robot, mobile robot, quadruped robot, robot arm, robotic hand, mobile manipulator, autonomous vehicle, drone, industrial robot, warehouse robot, service robot, agricultural robot, construction robot, medical robot, or surgical robot.

16. A computer-implemented method for world model gated physical artificial intelligence execution, comprising:
receiving, by a consequence evaluation system, a candidate physical action generated by an upstream physical AI controller for execution by one or more actuators of a physical AI agent;
prior to transmitting the candidate physical action to the one or more actuators, generating, by a world model executing on one or more processors, one or more predicted future physical states by applying the candidate physical action to a current physical-state representation of the physical AI agent and an operating environment;
evaluating, by a consequence evaluator, the one or more predicted future physical states against a constraint ledger;
issuing an actuation release authorization when the one or more predicted future physical states satisfy the constraint ledger; and
blocking transmission of the candidate physical action to the one or more actuators when the one or more predicted future physical states fail to satisfy the constraint ledger.

17. The computer-implemented method of claim 16, further comprising extracting, from an output of the world model, a consequence indicator comprising at least one of a collision indicator, force indicator, balance indicator, object-state indicator, human-proximity indicator, infrastructure indicator, resource indicator, ownership indicator, identity indicator, role indicator, policy indicator, or semantic hazard indicator.

18. The computer-implemented method of claim 16, wherein blocking transmission comprises at least one of modifying a parameter of the candidate physical action, decomposing the candidate physical action into sub-actions, delaying execution, rerouting the candidate physical action, derating a velocity, torque, force, current, acceleration, or power parameter, or transmitting a replanning request to the upstream physical AI controller.

19. A non-transitory computer-readable medium storing instructions that, when executed by one or more processors, cause the one or more processors to perform operations comprising:
receiving a candidate physical action generated by an upstream physical AI controller;
obtaining a current physical-state representation of a physical platform and an operating environment;
generating, using a world model separate from the upstream physical AI controller, one or more future physical states associated with execution of the candidate physical action;
evaluating the one or more future physical states against a plurality of constraint sets;
generating an actuation release authorization when the one or more future physical states satisfy the plurality of constraint sets; and
withholding the actuation release authorization when at least one of the plurality of constraint sets is not satisfied.

20. The non-transitory computer-readable medium of claim 19, wherein the operations further comprise causing an actuator gateway to permit a motor-control command only in response to verification of the actuation release authorization, and to remain fail-passive absent verification of the actuation release authorization.
